(19) United States
(12) Patent Application Publication
(10) Pub. No.: US 2006/0218983 A1
(43) Pub. Date: Oct. 5, 2006

(54) Anti-theft Device

(75) Inventor: Dale Edgar Horne, Elliston, MT (US)

Correspondence Address: Dale Edgar Horne, P.O. Box 67, Elliston, MT, 59728, US

(73) Assignee: Dale Edgar Horne, Elliston, MT (US)

(21) Appl. No.: 10/907,346

(22) Filed: Mar. 30, 2005

(51) Int. Cl. G05G 5/00; F16H 57/00

(52) U.S. Cl. 70/203

(57) ABSTRACT

A device for immobilizing the control pedals of a helicopter, aircraft or other vehicle protecting the same against theft or unauthorized use. The device is inserted between the two anti-torque control levers and locked in place with a padlock type lock. A conspicuous warning label is attached for notification of the device installation.

### CROSS REFERENCE TO RELATED APPLICATIONS

U.S. Pat. No. 1,274,427 August 1918 Landmann, Henry 70/200
U.S. Pat. No. 1,288,569 December 1918 Hallock, Lloyd B 70/200
U.S. Pat. No. 1,350,526 August 1920 Slaughter, Osceola C 70-200
U.S. Pat. No. 1,382,570 June 1921 Tanner, Elmer A 70/200
U.S. Pat. No. 1,414,390 May 1922 Wollard, Frank 70/200
U.S. Pat. No. 1,421,021 June 1922 Miller, Otto 70/200
U.S. Pat. No. 1,444,935 February 1923 Mokracek, Ralph A 70/200
U.S. Pat. No. 1,527,992 March 1925 Norton, John F 70/200
U.S. Pat. No. 2,556,900 June 1951 Buschhorn, Forrest L 70/230
U.S. Pat. No. 3,898,823 August 1975 Ludeman, Russell S 70/200
U.S. Pat. No. 4,475,366 October 1984 Marneris, Michael 70/258
U.S. Pat. No. 5,082,213 January 1992 Torres, Ramon L. 244/224
U.S. Pat. No. 5,582,363 December 1996 Davis, Don 244/1R

### STATEMENT REGARDING FEDERALLY SPONSERED RESEARCH OR DEVELOPMENT

“Not Applicable”

### THE NAMES OF THE PARTIES TO A JOINT RESEARCH AGREEMENT

“Not Applicable”

### INCORPORATION-BY-REFERENCE OF MATERIAL SUBMITTED ON A COMPACT DISC

“Not Applicable”

### BACKGROUND OF THE INVENTION

1. Field of the Invention

This invention relates, generally, to a device that locks two levers, and more particular two control pedals of an helicopter, aircraft or other vehicle together thereby immobilizing the levers or pedals.

2. Description of prior art

Aircraft vehicle theft have long been a problem. Accordingly, a number of inventors have developed various devices designed for unauthorized taking of aircraft and vehicles. Some of the devices are to prevent entry into the vehicles operator compartment or aircraft cockpits. Some of the devices are to prevent the movement of the vehicles steering or aircrafts aileron control yoke.

Although the art is well developed, aircraft and vehicles continue to be stolen. Helicopters in particular are vulnerable to theft as the prior art does not address an effective means of flight control lock.

Known prior art include U.S. Pat. No. 6,393,880; U.S. Pat. No. 3,898,823; U.S. Pat. No. 5,582,263; U.S. Pat. No. 1,527,992; U.S. Pat. No. 2,556,900.

U.S. Pat. No. 6,393,880 issued to David E. Vance Sr., on May 28, 2002 discloses an aircraft anti-theft device for immobilizing the control yoke of an aircraft, which works as intended for aircraft with a sliding control yoke affixed through the instrument panel. It does not consider an aircraft without this sliding control yoke, such as a helicopter.

U.S. Pat. No. 3,898,823 issued to Russell S. Ludeman, Aug. 12, 1975 includes brackets, secured to the pedals and control column wheel, interconnected by a tubular housing enclosing a piston like spring device which resiliently locks the wheel and control column against movement when parked so as to prevent unauthorized flight of the aircraft. It does not provide for anti-theft protection of a helicopter, which does not have a sliding control column and wheel.

U.S. Pat. No. 5,582,363 issued to Don Davis, Dec. 10, 1996 teaches a singular solid member 42 as seen in FIG. 2 and FIG. 4 having channels 52 and 54 therein which when vertically aligned, receive the steering columns 22 and 24 which seat in the blind ends 56 of the slots 52 and 54 respectively. This invention relates generally to aircraft instrument theft. Although it may be construed to prevent aircraft theft, it relies on a pair of parallel steering columns which project outwardly and rearward from the control panel toward the pilot and co-pilot respectively. Helicopters generally have the control columns protrude vertically from the cabin floor between the pilot and or co-pilots feet and this device will not adapt or prevent helicopter theft.

U.S. Pat. No. 1,527,992 issued to John F. Norton, Mar. 3, 1925 teaches a plate 9 as seen in FIG. 1 and FIG. 2, is rigidly fastened through the medium of a plurality of bolts 10 to the upper section of the foot board 5 and said plate is provided with a slot 11 adapted to receive the clutch pedal lever 6 and another slot 12 adapted to receive the brake pedal lever 8. Furthermore, a padlock 25 is provided, a bow which is inserted through a opening 27 provided in the housing 23 and openings 28 and 29. The problem with this as it relates to an aircraft or helicopter is that the fastening of a plate to the foot board of a aircraft or helicopter, changes the original design type certificate of that aircraft or helicopter and is not allowed per current Federal Aviation Regulations without further engineering data to asses the change of structural integrity of the helicopter or aircraft. In addition, the padlock shackle, as viewed in FIG. 1 is exposed and made vulnerable to cutting by any modern suitable tool. The present invention provides for the padlock shackle to be shrouded or protected and does not alter the aircrafts original design type certificate.

U.S. Pat. No. 2,556,990 issued to Forrest L. Buschhorn, Jun. 12, 1951 teaches a locking mechanism for preventing rotation of two T-shaped clamping screws by positioning hook 7 and 8, as seen in FIG. 1, on the T-shaped clamping screws. Then sliding shank 12 into body 11 and inserting padlock 18 through aligned openings 17. The problem with this as it relates to the present invention is that the hooks 7 and 8 as illustrated are designed to prevent a rotating moment of the clamping screws and would not secure the fore and aft opposing movements of an aircrafts control pedals. The hooks 7 and 8 could be bent open by these opposing forces and/or by a suitable pry bar type device. In addition, the padlock shackle, as viewed in FIG. 5, is exposed and made vulnerable to cutting by any modern suitable tool. The present invention solves this problem by providing a singular solid member which when used in conjunction with a padlock locking device completely surrounds the aircraft control pedals and eliminates the fore and aft opposing movements of the control pedals. The present invention provides for the padlock shackle to be shrouded or protected by passing through the singular solid member.

The description of the prior art represents the problems that are present and not addressed by the known previous inventions.

While these devices fulfill their respective, particular objectives and requirements, the aforementioned patents do not disclose a means for securing the flight controls of a helicopter. The present invention provides for the immobilization of the control pedals of an aircraft and more particular the anti-torque control pedals of a helicopter.

In these respects, the anti-theft device according to the present invention substantially departs from the conventional concepts and the designs of the prior art. The present invention provides an apparatus primarily developed for the purpose of immobilizing the control pedals of an aircraft, helicopter or other vehicle.

### BRIEF SUMMARY OF THE INVENTION

This invention relates to improvements in a locking device for the control levers of an aircraft and is primarily intended for application in helicopters.

The anti-torque control pedals of helicopters are disposed so that when parked they normally lie in vertical alignment, at which time the anti-torque rotor is at the neutral position, and it is the object of the present invention to provide a locking device cooperating with said anti-torque levers so as to maintain the same in such a position as to set the anti-torque rotor in a neutral position thereby positively locking the machine against theft or unauthorized use.

With the foregoing conception in mind, the invention has for its object to provide a device of this character comprising of a singular solid bar with vertical channels in the ends for the reception of the levers, the vertical channels will have one edge machined with a fillet or bevel, whereas if the top edge of one channel is beveled, then the bottom edge of the opposing channel is beveled, to facilitate installation between same levers. Said vertical channels maybe curved, square, tapered or of any geometry that corresponds to or generally mates to the said levers.

A further object is to provide a means of securing the singular solid bar to the levers by providing holes bore horizontally and perpendicular to said vertical channels, placing one hole on either side of the vertical channels to accept and to shroud the shackles of a padlock locking device that when inserted through said holes and locked will encompass and prevent the said levers from movement thereby locking the levers in a neutral position.

A further object is to provide the means for securing a conspicuous caution, warning or information tag, used to warn the operator that the levers are locked and that the device must be removed prior to aircraft operation, by providing a plurality of holes bore in the top of the singular solid bar, used to attach the warning label with rivets or screws. These holes may be of the through or blind type, which when the blind type, will be drilled to a depth not completely through the solid bar that will accept the shank of a rivet and when a rivet is driven or bucked will secure the same warning tag in a manner easily viewed by the operator.

The invention therefore, aims, to provide a locking device for helicopters which can be instantly applied so as to lock the same against theft but with ease can be removed from the helicopter when the lawful operator desires to use the same.

### BRIEF DESCRIPTION OF THE SEVERAL VIEWS OF THE DRAWINGS

FIG. 1 is a perspective drawing showing the anti-theft device in its applied relation to the two opposing anti-torque control pedals.

FIG. 2 is a top elevation view of the anti-theft device

FIG. 3 is an end sectional view of the anti-theft device

FIG. 4 is a top elevation view of the anti theft device showing the lock and warning tag in position with relation to the device

### DETAILED DESCRIPTION OF THE INVENTION

With the above and other objects in clear view, the invention consists in the novel construction, combination and arrangement of parts, herein fully described, illustrated and claimed.

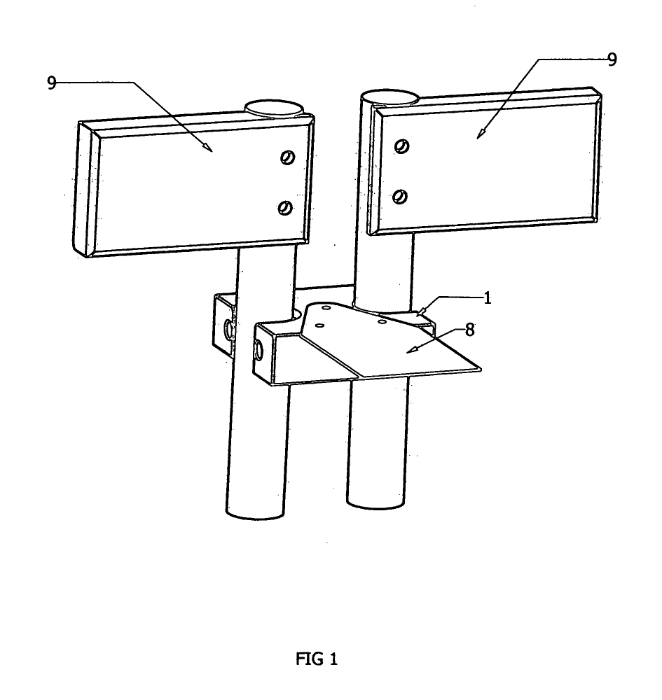

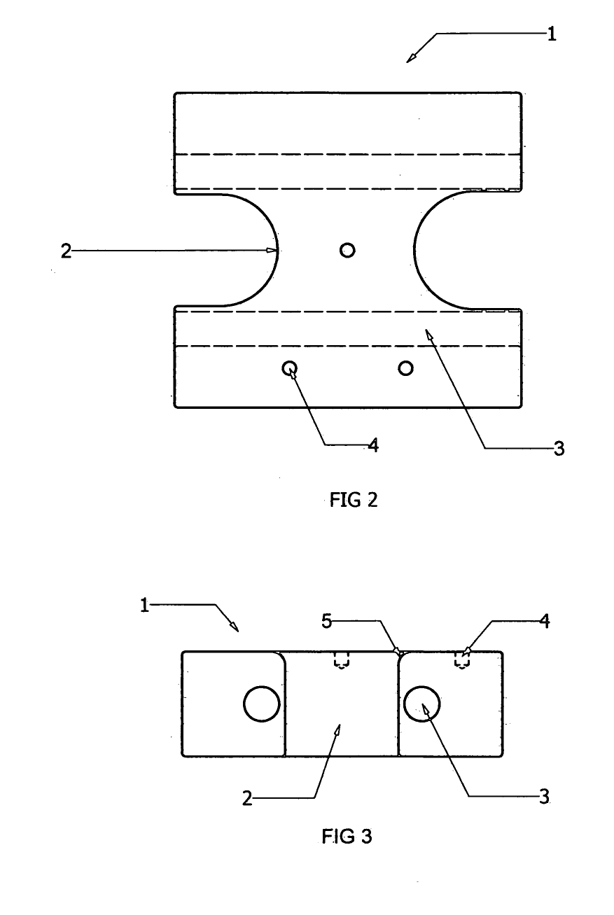

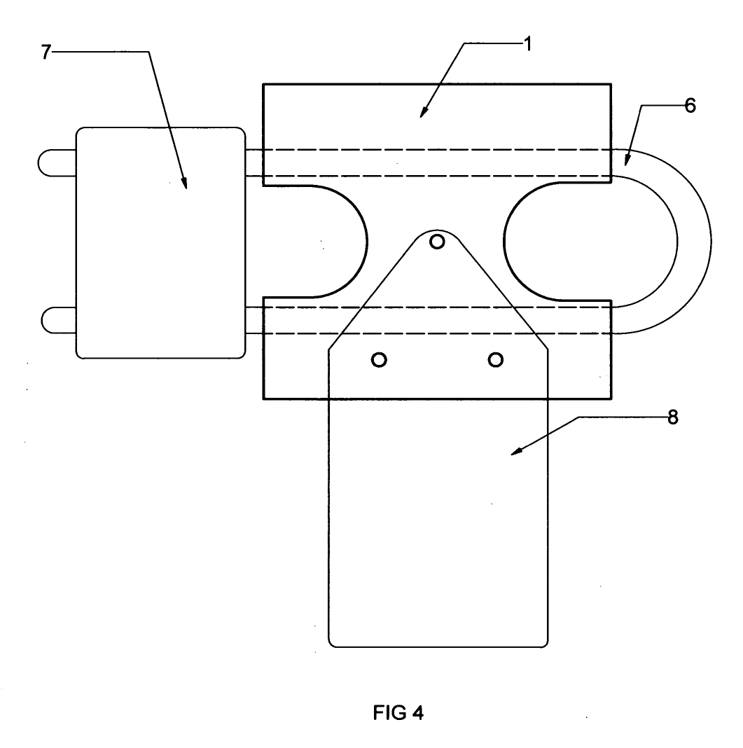

The anti-torque control pedal locking device contemplated in this invention comprises a singular solid member 1, shown in the form of a block or bar, preferably composed of aluminum, aluminum alloy or other suitable metal. The solid member 1 is formed having two vertical channels 2 in opposing ends capable of receiving control levers 9 as illustrated in FIG. 1. Each vertical channel 2 has one each chamfered or beveled edge 5, FIG. 3, that will be diagonally opposite of the other to facilitate the insertion of solid member 1 between control levers 9, after which a padlock shackle 6, FIG. 4, is inserted into two holes 3, FIG. 2, which bore horizontally through solid member 1, with one hole 3 being on one side of vertical channels 2 and one other hole 3 being on the opposite side of vertical channels 2, thereby protecting or shrouding the padlock shackle 6 and securing both control levers 9 within the vertical channels 2. The padlock shackle 6 is then fastened to the main body portion 7 of the padlock in the usual well-known manner, its operation being controlled by a key or other suitable means. When locked in this position the control levers 9 are held firmly together in a neutral plane and are prevented from movement fore or aft in their normal direction thereby preventing the unauthorized use or control of the helicopter or other vehicle. A caution or warning tag 8, FIG. 4, is affixed to solid member 1 by rivets or screws at holes 4, thereby notifying the authorized user of positive control lever lock, with removal of lock and anti-theft device being necessary prior to use, and as a prominent visual criminal determent.

With respect to the above description then, it is realized that the optimum dimensional relationship for the parts of the invention, to include variations in size, materials, shape, form, function and manner of operation, assembly and use, are deemed readily apparent and obvious to a person skilled in the art, and all equivalent relationships to those illustrated in the drawings and described in the specifications are intended to be encompassed by the present invention.

Therefore, the forgoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be restored to, falling within the scope of the invention.

1-4. (canceled)

5. An anti-theft device for immobilizing the control pedals or levers of a helicopter, aircraft or other vehicle, comprising of a singular solid member having vertical channels on opposing ends for receiving said levers, having holes bore horizontally through said member to accept and protect the shackles of a padlock locking device and the provisions for calling attention to the device installation by the attachment of a warning label in a conspicuous manner.
